(19) United States
(12) Patent Application Publication
(10) Pub. No.: US 2023/0295460 A1
(43) Pub. Date: Sep. 21, 2023

(54) MULTILAYER COATING SYSTEM, COATING METHOD, COATING STRUCTURE AND COATED SUBSTRATE

(71) Applicants: Hong Li, Panjin, Liaoning Province (CN); Junyu Wamg, Panjin, Liaoning Province (CN)

(72) Inventor: Junyu Wang, Panjin (CN)

(73) Assignee: BOYAZ ENERGY, Seoul (KR)

(21) Appl. No.: 18/013,958

(22) PCT Filed: Feb. 4, 2021
(86) PCT No.: PCT/CN2021/075273

§ 371 Date: Dec. 30, 2022

(30) Foreign Application Priority Data
Jul. 1, 2020 (CN) 202010621354.3

(51) Int. Cl. C09D 175/06; C09D 133/08; C09D 175/14; C09D 5/00; C09D 167/00

(52) U.S. Cl. CPC C09D 175/06; C09D 133/08; C09D 175/14; C09D 5/002; C09D 167/00

(57) ABSTRACT

The invention discloses a multilayer coating system, which belongs to the technical field of coatings, the said multilayer coating system comprises an isocyanate curing coating and a Real Michael addition crosslinkable coating, wherein the isocyanate curing coating comprises at least one resin X containing an acidic carbon-hydrogen bond or an unsaturated carbon-carbon double bond with an electron-withdrawing group, and the resin X performs a Michael addition reaction with the Real Michael addition crosslinkable coating, so that the interlayer adhesion of the two coatings is greatly improved. According to the said multilayer coating system, the invention further discloses a coating method, a coating structure, and a coated substrate. The invention also provides an isocyanate curing coating, which is used for a primer coat for a Real Michael addition crosslinkable coating and a use thereof for improving the adhesion of the Real Michael addition crosslinkable coating to a substrate.

### TECHNICAL FIELD

The present disclosure relates to the field of coatings, specifically to a multilayer coating system, a coating method, a coating structure, and a coated substrate.

### BACKGROUND

Coating materials crosslinked by a Michael addition reaction is already commercially available, such as those described in EP2374836A1. With the aid of the Michael addition reaction, a component A containing at least 2 acidic active methylene C—H bonds and a component B containing at least 2 unsaturated double bonds with an electron-withdrawing group may be rapidly cured at room temperature in the presence of a base catalyst C. Patents EP2374836A1 and WO2018005077A1 described special catalysts. The catalysts themselves are very weak in basicity and cannot catalyze the Michael addition reaction. When used in coatings they can decompose, release carbon dioxide and become strong bases which can catalyze Michael addition reactions. With the aid of the catalysts, the pot life of the Michael addition coating systems is significantly extended.

The isocyanate curing coating may be used as primers or middle coatings for Real Michael addition crosslinkable coatings in the prior art. However, due to the lack of reactive groups with the Michael addition, the adhesion of the Real Michael addition crosslinkable coatings to such isocyanate curing coatings is severely insufficient, and thus the use of Michael addition coatings as basecoat, clearcoat or topcoat is still limited.

### SUMMARY

### Problems to be Solved by the Disclosure

The adhesion of the Real Michael addition crosslinkable coatings on many substrates is insufficient, which leads to peeling off of the film in practical use. Therefore, the coating industry is currently searching for a method to overcome this shortness of the Real Michael addition crosslinkable systems.

### Means for Solving the Problems

It is an object of the present disclosure to provide a multilayer coating system, comprising:
a. an isocyanate curing coating, comprising:
   i. at least one hydroxyl-containing or amino-containing resin PA;
   ii. at least one isocyanate curing agent PB;
   iii. at least one resin X containing an acidic carbon-hydrogen bond or an unsaturated carbon-carbon double bond with an electron-withdrawing group;
b. a Real Michael addition crosslinkable coating coated on the isocyanate curing coating, comprising:
   i. at least one resin A containing two or more acidic carbon-hydrogen bonds;
   ii. at least one resin B containing two or more unsaturated carbon-carbon double bonds with an electron-withdrawing group;
   iii. a catalyst or latent catalyst C for initiating the Michael addition reaction; and
   iv. optionally, a reaction regulator D.

According to the present disclosure, the proportion of the resin X in the isocyanate curing coating is 0.5 wt % to 50 wt %, preferably 2 wt % to 30 wt %, and most preferably 3 wt % to 10 wt %.

According to the present disclosure, the resin X contains a group which can react with PA or PB, the group is preferably a hydroxyl group or an isocyanate group; the equivalent of the hydroxyl group or the isocyanate group in the resin X is 100 g/mol to 10000 g/mol, and preferably 250 g/mol to 2500 g/mol.

According to the present disclosure, the equivalent of the acidic carbon-hydrogen bond or the unsaturated carbon-carbon double bond with an electron-withdrawing group in the resin X is less than 5000 g/mol, preferably less than 2000 g/mol, and most preferably less than 1000 g/mol.

According to the present disclosure, the number-average molecular weight of the resin X is less than 50000, preferably less than 10000, and particularly preferably less than 3000.

The present disclosure accordingly also provides the isocyanate curing coating described above, and a use thereof as a primer for a Real Michael addition crosslinkable coating and a use for improving the adhesion of the Real Michael addition crosslinkable coating to a substrate.

It is another object of the present disclosure to provide a coating method, comprising:
a.S1, applying the isocyanate curing coating in the multilayer coating system described above on a substrate surface;
b.S2, curing or partially curing the isocyanate curing coating;
c.S3, applying the Real Michael addition crosslinkable coating in the multilayer coating system described above on the isocyanate curing coating; and;
d.S4, curing the Real Michael addition crosslinkable coating.

According to the invention, the substrate surface in the step S1 may be chemically treated, modified, or coated with a primer coat.

It is another object of the present disclosure to provide a coating structure, comprising: an isocyanate curing coating layer and a Real Michael addition crosslinkable coating layer, wherein the isocyanate curing coating layer is a coating using the isocyanate curing coating in the above multilayer coating system, and the Real Michael addition crosslinkable coating layer is a coating using the Real Michael addition crosslinkable coating in the above multilayer coating system. The isocyanate curing coating layer and the Real Michael addition crosslinkable coating layer are respectively a primer and a topcoat of the coating structure; or the isocyanate curing coating layer and the Real Michael addition crosslinkable coating layer are respectively a middle coat and a topcoat of the coating structure; or the isocyanate curing coating layer and the Real Michael addition crosslinkable coating layer are respectively a topcoat and a clearcoat of the coating structure.

According to the present disclosure, the Real Michael addition crosslinkable coating layer is a single layer or comprises at least two sublayers.

It is a further object of the present disclosure to provide a coated substrate, comprising: a coating formed by the multilayer coating system described above; or a coating obtained by the coating method described above; or a coating having the same coating structure as described above.

### Effects of the Disclosure

The resin X exists in the cured isocyanate coating and undergoes a Michael addition reaction with the Real Michael addition crosslinkable coating applied later, thereby greatly improving the interlayer adhesion of the two coatings. Since this process involves the design of the resins as well as the optimization and the understanding of the multi-layer coating system as a whole, this improvement is not apparent. The improvement may greatly expand the application range of the Real Michael addition crosslinkable coating and promote the commercial application of the low-solvent type coating.

### DETAILED DESCRIPTION

First of all, it should be understood by those skilled in the art that the embodiments described herein are only for explaining the technical principles of the present disclosure and are not intended to limit the scope of protection of the present disclosure.

### Terms and Definition

As used herein, “Real Michael addition crosslinkable coating” refers to a coating utilizing a Michael addition reaction to perform a crosslinking and curing.

As used herein, “isocyanate curing coating” refers to a coating using an isocyanate or isocyanate prepolymer as a curing agent.

As used herein, when referring to the composition of a coating, “resin” refers to a component capable of forming a polymer in the coating after curing, including monomers, dimers, oligomers, and polymers.

In the present specification, the numerical range indicated by using “numerical value A to numerical value B” refers to a range including the endpoints of the numerical values A and B.

In the present specification, the numerical range indicated by using “or more” or “or less” refers to a numerical range that includes a number itself.

In the present specification, the meaning indicated by using “may” includes both the meaning of performing a certain process and the meaning of not performing a certain process.

In the present specification, the use of “optionally” or “optional” indicates the use or non-use of factors such as certain substances, components, operation steps, application conditions, and the like.

In the present specification, the unit names used are all standard international unit names, and unless otherwise stated, “%” is used to indicate weight or mass percentage.

In the present specification, the “preferred embodiment” and “embodiment” and the like mentioned mean that a particular element (e.g., feature, structure, property, and/or characteristic) described in connection with the embodiment is included in at least one embodiment described herein and may or may not be present in other embodiments. In addition, it should be understood that the element may be combined in any suitable manner in the various embodiments.

### Multilayer Coating System

The present disclosure provides a multilayer coating system, comprising:
a. an isocyanate curing coating, comprising:
   i. at least one hydroxyl-containing or amino-containing resin PA;
   ii. at least one isocyanate curing agent PB;
   iii. at least one resin X containing an acidic carbon-hydrogen bond or an unsaturated carbon-carbon double bond with an electron-withdrawing group;
b. a Real Michael addition crosslinkable coating coated on the isocyanate curing coating, comprising:
   i. at least one resin A containing two or more acidic carbon-hydrogen bonds;
   ii. at least one resin B containing two or more unsaturated carbon-carbon double bonds with an electron-withdrawing group;
   iii. a catalyst or latent catalyst C for initiating a Michael addition reaction; and
   iv. optionally, a reaction regulator D.

The isocyanate curing coating comprises the following components based on the weight: the proportion of the resin PA is 5 wt % to 70 wt %, preferably 15 wt % to 60 wt %, and most preferably 20 wt % to 55 wt %; the proportion of the isocyanate curing agent PB is 4 wt % to 40 wt %, preferably 8 wt % to 35 wt %, and most preferably 10 wt % to 30 wt %; the proportion of the resin X is 1 wt % to 50 wt %, preferably 2 wt % to 30 wt %, and most preferably 3 wt % to 10 wt %.

The hydroxyl-containing or amino-containing resin PA is a resin having the ability to react with isocyanate, and the coating film is cured by the reaction between the hydroxyl group or amino group contained in the resin PA and isocyanate. The selection of the resin PA includes hydroxyl acrylic resin, hydroxyl polyester resin, hydroxyl polyether resin, polyaspartic ester resin, hydroxyl acrylic dispersion, hydroxyl polyester dispersion, and hydroxyl polyether dispersion, and the like.

The isocyanate curing agent PB is a hardener containing isocyanate groups, which is selected from the group consisting of aliphatic isocyanates, alicyclic isocyanates, and aromatic isocyanates, preferably isocyanate oligomers such as HDI trimers, IPDI trimers, HDI biuret, HDI polyol adducts, and the like.

Preferably, in the isocyanate curing coating, the molar ratio of the hydroxyl group or amino group to the isocyanate group is 1:0.5 to 1:3, preferably 1:0.7 to 1:2, and most preferably 1:0.8 to 1:1.8.

The proportion of the resin X in the isocyanate curing coating is 0.5 wt % to 50 wt %, preferably 2 wt % to 30 wt %, and most preferably 3 wt % to 10 wt %. The resin X contains a group which can react with the resin PA or the isocyanate curing agent PB, and the group is preferably a hydroxyl group or an isocyanate group. The equivalent of the hydroxyl group or the isocyanate group in the resin X is 100 g/mol to 10000 g/mol, and preferably 250 g/mol to 2500 g/mol. The equivalent of the acidic carbon-hydrogen bond or the unsaturated carbon-carbon double bond with an electron-withdrawing group in the resin X is less than 5000 g/mol, preferably less than 2000 g/mol, and most preferably less than 1000 g/mol. The number-average molecular weight of the resin X is less than 50000, preferably less than 10000, and particularly preferably less than 3000.

The resin X exists in the cured isocyanate curing coating and undergoes a Michael addition reaction with the Real Michael addition crosslinkable coating coated later, thereby greatly improving the interlayer adhesion of the two coatings.

The selection of the resin X includes (poly) malonates, substituted (poly) malonates, (poly) acetoacetates, substituted (poly) acetoacetates, malonate-modified epoxy compounds, acetoacetate-modified epoxy compounds, malonate or acetoacetate-modified polycarbonates, malonate or acetoacetate-modified polyamides, malonate or acetoacetate-modified polyacrylates, malonate or acetoacetate-modified polyvinyl alcohol, acrylate monomers or acrylate oligomers. Preferably the resin X may contain a compound capable of reacting with isocyanate or a compound containing an isocyanate group, such as hydroxyl-containing (poly) malonates, hydroxyl-containing (poly) acetoacetates, hydroxyl-containing acrylate monomers, hydroxyl-containing acrylate oligomers, prepolymers formed by hydroxyl-containing acrylate monomers and isocyanates, prepolymers formed by hydroxyl-containing (poly) malonates and isocyanates, and the like. The resin X may further be a mixture of the above compounds.

In the present disclosure, the isocyanate curing coating may be a solvent-borne coating, a water-borne coating, or a solvent-free coating.

The isocyanate curing coating may include any one or more of inorganic fillers, inorganic pigments, organic pigments, anti-corrosive pigments, coating additives (dispersants, leveling agents, thickeners, anti-sagging agents, defoamers, flatting agents, light stabilizers, adhesion promoters, and the like), catalysts and solvents.

The Real Michael addition crosslinkable coating comprises the following components based on the weight: the proportion of the resin A is 5 wt % to 70 wt %, preferably 10 wt % to 60 wt %; the proportion of the resin B is 3 wt % to 70 wt %, preferably 10 wt % to 60 wt %; the proportion of the catalyst C is 0.1 wt % to 20 wt %, preferably 1 wt % to 10 wt %. While the components of the Real Michael addition crosslinkable coating meet the above proportions, the molar ratio of the functional groups of the acidic carbon-hydrogen bond contained in the resin A to the functional groups of the active double bond contained in the resin B is between 1:0.2 and 1:5, preferably between 1:0.8 and 1:1.2. The molar ratio of the acidic carbon-hydrogen bond contained in the resin A to the active component in the catalyst is between 1000:1 and 1:1, preferably between 250:1 and 10:1.

The resin A in the Real Michael addition crosslinkable coating containing activated methylene or methine groups (CH) is known in the art. A suitable resin A is preferably a polymer having the structure represented by the general formula (2):

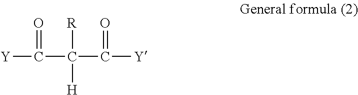

wherein R is hydrogen or alkyl, aryl or aralkyl; Y and Y′ are the same or different organic group; or wherein —C(═O)—Y and/or —C(═O)—Y′ is replaced by CN or phenyl.

In one embodiment, the resin A in the Real Michael addition crosslinkable coating contains methylene or methine groups bonded between at least two electron-withdrawing groups, and the selection of the resin A includes malonates, acetoacetates, and the preferred selection further includes oligomers or polymers of polyesters, polyurethanes, polyacrylates, epoxy resins, polycarbonates, polyamides based on malonic acid, and polyols, polyvinyl alcohols, or epoxy resins esterified by acetoacetate.

The polyesters containing malonate groups are preferably obtainable by a transesterification of dimethyl malonate or diethyl malonate with polyfunctional alcohols. The polyurethanes containing malonate groups are obtainable by reaction of polyisocyanates with polyols and hydroxyl-containing esters of malonic acid or by the transesterification of dialkyl malonates with hydroxyl-containing polyurethanes. The epoxy esters containing malonate groups are obtainable by esterification of malonic acids or a malonic acid monoesters or acid functionalized malonate polyesters with epoxy resins.

The oligomers or polymers containing acetoacetate groups are obtainable by the transesterification of polyols and/or hydroxy-functionalized polyethers, polyesters, polyacrylates, vinyl groups and epoxy oligomers or polymers with diketenes or alkyl acetoacetates, such components may also be obtained by copolymerizing acetoacetate group-containing (meth) acrylic monomers with other vinyl groups and/or (meth) acrylic functionalized monomers.

In one embodiment, the resin A is a polymer formed by copolymerizing C₁₋₁₀ alkyl malonates with C₁₋₁₀ diols and optionally aliphatic diacids; particularly preferably, the resin A is a polymer formed by copolymerizing C₂₋₄ alkyl malonates with C₃₋₈ diols and optionally aliphatic diacids; and most preferably, the resin A is a polymer obtained by polymerizing diethyl malonate with neopentyl glycol and optionally aliphatic diacids. The aliphatic diacid monomers are used for adjusting the glass transition temperature of the resin A, and can be selected by those skilled in the art according to actual requirements, and linear, branched or cyclic aliphatic diacids with 1 to 20 carbon atoms are preferred, including but not limited to oxalic acid, malonic acid, succinic acid, glutaric acid, adipic acid, pimelic acid, azelaic acid, sebacic acid, and hexahydrophthalic acid.

The resin B may generally be an olefinic unsaturated component in which the carbon-carbon double bonds are activated via an electron-withdrawing group, such as a carbonyl activation at α-position. Examples of the groups containing an activated unsaturated carbon-carbon double bond include acryloyl groups, maleate groups, fumarate groups, itaconate groups, and the like.

A suitable resin B is known in the art, such as acrylates, acrylamides, polyesters based on maleic acid, fumaric acid, and/or itaconic acid, and polyesters based on maleic anhydride and/or itaconic anhydride. Furthermore, the resin B may also be a polymer with pendants of the aforementioned groups containing activated unsaturated carbon-carbon double bonds, and the polymer is preferably polyester, polyurethane, polyether or alkyd resin.

A preferred selection of the resin B in the Real Michael addition crosslinkable coating includes acrylate monomers, urethane acrylate oligomers, polyester acrylate oligomers, epoxy acrylate oligomers, and such compounds have 1 to 30 acrylate groups.

As the catalyst or latent catalyst C, strong bases known in the art, such as alkali metal hydroxides, alkali metal alkoxides, hydroxide quaternary ammonium salts or amine compounds (diazepine compounds, guanidine compounds, amidine compounds, pyridine compounds), may be selected for catalysis; however, the catalyst or latent catalyst C may also be a basic latent catalyst which is weak in basicity itself and can be converted to a strong base catalyst under proper conditions to catalyze reactions, preferably the carbonic acid monoester salts and carbamates as described in patents EP 2374836A1 and WO2018005077A1. It is particularly preferred that the salts containing cations which are organophilic to the solvents, such as tetrabutylammonium monoethyl carbonate and tetrabutylammonium dimethylcarbamate. Alcohol or alcohol ether solvents may be appropriately added to the catalyst.

Preferably, the Real Michael addition crosslinkable coating further includes a reaction regulator D containing a X—H group. The X—H group has slightly stronger acidity than that of the carbon-hydrogen bond in the resin A. The reaction regulator D is selected from molecules containing nitrogen-hydrogen bonds, such as substituted or unsubstituted succinimide, glutarimide, hydantoin, triazole, pyrazole, imidazole, and uracil.

It is further specified that the Real Michael addition crosslinkable coating may include any one or more of inorganic fillers, inorganic pigments, organic pigments, coating additives (dispersants, leveling agents, thickeners, anti-sagging agents, defoamers, flatting agents, light stabilizers, and the like), pot life extenders, open time extenders and solvents to improve the properties of the coating.

The Real Michael addition crosslinkable coating may include one or more organic solvents or water to adjust the operation viscosity. Useful solvents may include water and other organic solvents free of acidic impurities such as alkyl acetates, alcohols, N-alkyl pyrrolidones, glycol ethers (esters), propylene glycol ethers (esters), ketones, and the like. It is preferable to include alcohol and alcohol ether solvents as they can improve the open time.

The VOC content of the Real Michael addition crosslinkable coating is less than 500 g/L, preferably less than 300 g/L, more preferably less than 150 g/L, and most preferably less than 50 g/L

### Coating Method

The present disclosure also provides a coating method, comprising the following steps of:
a.S1, applying the isocyanate curing coating of the coating system described above on a substrate surface;
b.S2, curing or partially curing the isocyanate curing coating;
c.S3, applying the Real Michael addition crosslinkable coating of the coating system described above on the isocyanate curing coating; and
d.S4, curing the Real Michael addition crosslinkable coating.

The substrate surface in step S1 may be chemically treated, modified or coated with a primer.

The partial curing in step S2 means: at least the surface drying (touch drying) is achieved

In step S2 and step S4, the curing temperature of the isocyanate curing coating and the Real Michael addition crosslinkable coating may be 0 to 100° C. and preferably 10 to 70° C.

In the process of step S2 to step S4, the interval time between the application of the isocyanate curing coating and the applying of the Real Michael addition crosslinkable coating may be selected to be 15 minutes to 2 years, preferably 20 minutes to 1 month, and particularly preferably 30 minutes to 1 week.

### Coating Structure

The present disclosure also discloses a coating structure, comprising an isocyanate curing coating layer and a Real Michael addition crosslinkable coating layer, wherein the isocyanate curing coating layer is a coating using the isocyanate curing coating of the above coating system, and the Real Michael addition crosslinkable coating layer is a coating using the Real Michael addition crosslinkable coating of the above coating system.

The isocyanate curing coating layer and the Real Michael addition crosslinkable coating layer are respectively a primer and a topcoat of the coating structure; or the isocyanate curing coating layer and the Real Michael addition crosslinkable coating layer are respectively a middle coat and a topcoat of the coating structure; or the isocyanate curing coating layer and the Real Michael addition crosslinkable coating layer are respectively a basecoat and a clearcoat of the coating structure. The Real Michael addition crosslinkable coating layer is a single layer or comprises at least two sublayers, that is, the Real Michael addition crosslinkable coating may be coated on the Real Michael addition crosslinkable coating for multiple times, so as to achieve a desired coating effect, such as a combination of top coats of various colors, a combination of a basecoat and a clearcoat, or a refinishing of the Real Michael addition crosslinkable coating. The Real Michael addition crosslinkable coating used in the above cases does not depart from the above formulation requirements for the Real Michael addition crosslinkable coating.

### Coated Substrate

The present disclosure also discloses a coated substrate, comprising: a coating formed by the coating system described above, or a coating obtained by the coating method described above; or a coating having the same coating structure as described above. The substrate may be a metal substrate, particularly preferably a steel substrate which includes all types of pretreated steel substrates, such as electroplating steel, galvanized steel, and phosphating steel; and an aluminum substrate. Likewise, the substrate may also be selected from ABS substrate, polycarbonate substrate, glass fiber or carbon fiber reinforced material, PET, PBT, PA6, PA66, thermoplastic polyolefin, PVC, PMMA, PS, and the like.

### EXAMPLES

The following is a description of some embodiments of the present disclosure, which is only given by way of examples.

Adhesion Test:
a. The adhesion results described in the following examples were tested according to the cross-cut adhesion test of ISO/DIN 2409. The classification was briefly described as follows:
b.0: The edges of the cuts are completely smooth; none of the squares of the lattice is detached.
1: Detachment of small flakes of the coating at the intersection of the cuts. A cross-cut area not significantly greater than 5% is affected.
2: The coating has flaked along the edges and/or at the intersection of the cuts. A crosscut area significantly greater than 5%, but not significantly greater than 15% is affected.
3: The coating has flaked along the edges partly or wholly in large ribbons, and/or it has flaked partly or wholly on different parts of the squares. A cross-cut area significantly greater than 15%, but not significantly greater than 35%, is affected.
4: The coating has flaked along the edges of the cuts in large ribbons and/or same squares have detached partly or wholly. A cross-cut area significantly greater than 35%, but not significantly greater than 65% is affected.
5: Any degree of flaking that cannot even be classified by classification 4.

### Substrate:

In order to test the adhesion of the given Examples and Comparative Examples, the coatings were applied to phosphated steel plates unless otherwise stated.

The following description of trade names is referred to:
a. Bayhydur® XP2655: hydrophilic aliphatic polyisocyanate based on hexamethylene diisocyanate (HDI), commercially available from Covestro;
Acrylic resin BS-965: commercially available from Jiangsu Sanmu group
Acrylic resin BS-962: commercially available from Jiangsu Sanmu group
Basonate HI 100: commercially available from BASF
Acrylic dispersion JJ600: commercially available from Jinhuashengxin Materials

### Preparation of Malonate-Containing Polyester Resin X1:

416 g of neopentyl glycol, 560 g of diethyl malonate, and 5 g of an ethanol solution of sodium hydroxide (10 wt %) were added to a four-neck flask with a stirrer and a thermometer. The reaction mixture was heated to 130° C., and the distilled solvent and the reaction byproduct were collected. Then, the temperature was gradually increased to 200° C., and the ethanol was removed under reduced pressure. The theoretical hydroxyl value of the obtained product was 85 mg KOH/g, the malonate equivalent weight was 186 g/equivalent, and the active C—H bond equivalent was 93 g/mol.

### Preparation of Acrylate Group-Containing Isocyanate X2:

150 g of Bayhydur XP2655 and 25 g of pentaerythritol triacrylate were uniformly mixed, and the mixture was charged into a sealed container and left to stand overnight, and the isocyanate content of the obtained product was 15.8%.

### Preparation of Latent Catalyst C1:

100 g of a 40 wt % aqueous tetrabutylammonium hydroxide solution, 100 g of diethyl carbonate, and 60 g of isopropanol were mixed uniformly, and the mixture was charged to a sealed container and left to stand overnight.

### Preparation of Real Michael Addition Crosslinkable Paint:

TABLE 1
Preparation of Real Michael Addition
crosslinkable clearcoat (Paint A)

| Component | Paint A | |
|---|---|---|
| Malonate-Containing | 93 | g |
| polyester resin X1 | | |
| TMPTA | 99 | g |
| Leveling agent | 0.2 | g |
| Solvent | 50 | g |

TABLE 2
Preparation of Real Michael Addition
crosslinkable White Paint (Paint B)

| Component | Paint B | |
|---|---|---|
| Di-TMPTA | 250 | g |
| Barium sulfate | 100 | g |
| Talc | 80 | g |
| Titanium dioxide | 200 | g |
| Dispersant | 10 | g |
| Ground to 15 micrometers, | | |
| then added | | |
| Malonate-Containing | 206 | g |
| polyester resin X1 | | |
| Solvent | 100 | g |

### Example 1: Preparation of Malonate-Containing Two-Component Polyurethane Primer

The two-component polyurethane primer was prepared as shown in table 3, and the two components were mixed thoroughly in the proportions and sprayed onto a phosphated steel plate. After one week, 100 g of paint A and 5 g of catalyst C1 were thoroughly mixed and sprayed onto the steel plate coated with the primer. After 24 hours, the adhesion was tested as described in ISO/DIN 2409 and found to be very good, and the classification of the test was 0.

### Example 2: Preparation of Acrylate-Containing Two-Component Polyurethane Primer

The two-component polyurethane primer was prepared as shown in table 3, and the two components were mixed thoroughly in the proportions and sprayed onto a phosphated steel plate. After one week, 100 g of paint A and 5 g of catalyst C1 were thoroughly mixed and sprayed onto the steel plate coated with the primer. After 24 hours, the adhesion was tested as described in ISO/DIN 2409 and found to be very good, and the classification of the test was 0.

### Comparative Example 1: Preparation of Conventional Acrylic Polyurethane Primer

The two-component polyurethane primer was prepared as shown in table 3, and the two components were mixed thoroughly in the proportions and sprayed onto a phosphated steel plate. After one week, 100 g of paint A and 5 g of catalyst C1 were thoroughly mixed and sprayed onto the steel plate coated with the primer. After 24 hours, the adhesion was tested as described in ISO/DIN 2409 and found to be very poor. The clearcoat peeled off completely, and the classification of the test was 5.

TABLE 3
Formulation of Two-Component
Solvent Type Polyurethane Primer

| | | | |
|---|---|---|---|
| | | | Comparative |
| Component | Example 1 | Example 2 | Example 1 |

Base paint

| | | | | | | |
|---|---|---|---|---|---|---|
| Acrylic resin BS-965 | 40 | g | 40 | g | 40 | g |
| Acrylic resin BS-962 | 20 | g | 20 | g | 20 | g |
| Titanium dioxide | 18 | g | 18 | g | 18 | g |
| Barium sulfate | 17.5 | g | 17.5 | g | 17.5 | g |
| Bentonite | 0.3 | g | 0.3 | g | 0.3 | g |
| Dispersant | 0.3 | g | 0.3 | g | 0.3 | g |
| Coating additive | 0.6 | g | 0.6 | g | 0.6 | g |
| Diluent | 60 | g | 60 | g | 60 | g |
| Malonate-Containing | 8 | g | | | | |
| polyester resin X1 | | | | | | |
| Pentaerythritol | | | 8 | g | | |
| triacrylate | | | | | | |

Curing agent

| | | | | | | |
|---|---|---|---|---|---|---|
| Basonate HI 100 | 15 | g | 17 | g | 13 | g |
| Diluent | 24 | g | 28 | g | 20 | g |

### Example 3: Preparation of Acrylate-Containing Waterborne Polyurethane Paint

The two-component waterborne polyurethane primer was prepared as shown in table 4, and the two components were mixed thoroughly in the proportions and sprayed onto a phosphated steel plate. After one week, 100 g of paint B and 5 g of catalyst C1 were thoroughly mixed and sprayed onto the steel plate coated with the primer. After 24 hours, the adhesion was tested as described in ISO/DIN 2409 and found to be very good, and the classification of the test was 0 to 1.

### Comparative Example 2: Preparation of Conventional Waterborne Polyurethane Paint

The two-component waterborne polyurethane primer was prepared as shown in table 4, and the two components were mixed thoroughly in the proportions and sprayed onto a phosphated steel plate. After one week, 100 g of paint B and 5 g of catalyst C1 were thoroughly mixed and sprayed onto the steel plate coated with the primer. After 24 hours, the adhesion was tested as described in ISO/DIN 2409 and found to be very poor. The topcoat peeled off completely and the classification of the test was 5.

TABLE 4
Formulation of Two-Component
Waterborne Polyurethane Primer

| | | |
|---|---|---|
| | | Comparative |
| Component | Example 3 | Example 2 |

Base paint

| | | | | |
|---|---|---|---|---|
| Acrylic dispersion | 40 | g | 40 | g |
| JJ600 | | | | |
| Antirust pigment | 8 | g | 8 | g |
| Titanium dioxide | 10 | g | 10 | g |
| Filler | 20 | g | 20 | g |
| Coating additive | 2 | g | 2 | g |
| Deionized water | 10 | g | 10 | g |
| Co-solvent | 10 | g | 10 | g |

Curing agent

| | | | | |
|---|---|---|---|---|
| Bayhydur XP2655 | | | 12 | g |
| Acrylate group- | 15 | g | | |
| containing | | | | |
| isocyanate X2 | | | | |
| Co-solvent | 10 | g | 13 | g |

### Example 4: Malonate-Containing Two-Component Polyurethane Primer for Coating on Plastic Substrate

The two-component polyurethane primer was prepared as in Example 1, and the two components were mixed thoroughly in the proportions and sprayed onto a polycarbonate substrate and a PC/ABS substrate. After one week, 100 g of paint A and 5 g of catalyst C1 were thoroughly mixed and sprayed onto the plate coated with the primer. After 24 hours, the adhesion was tested as described in ISO/DIN 2409 and found to be very good, and the classification of the test was 0.

The above description of the disclosed examples is provided to enable those skilled in the art to achieve or use the present disclosure. Various modifications to these examples will be readily apparent to those skilled in the art, and the generic principles defined herein may be implemented in other examples without departing from the spirit or scope of the present disclosure. Thus, the present disclosure is not to be limited to these examples shown herein but shall accord with the widest scope consistent with the principles and novel characteristics disclosed herein.

### INDUSTRIAL APPLICABILITY

The multilayer coating system of the present disclosure is particularly suitable for coating large parts, such as general industrial machinery, Agriculture, construction and earth-moving machinery and equipment, automobiles, trains, ships and airplanes.

What is claimed is:

1. A multilayer coating system, comprising:
I. an isocyanate curing coating layer, comprising:
(1) at least one hydroxyl-containing or amino-containing resin PA;
(2) at least one isocyanate curing agent PB;
(3) at least one resin X containing at least one activated methylene or methine group (CH) or one unsaturated carbon-carbon double bond with an electron-withdrawing group;
II. a Real Michael addition crosslinkable coating layer coated on the isocyanate curing coating layer, comprising:
(1) at least one resin A containing two or more activated methylene or methine groups (CH);
(2) at least one resin B containing two or more unsaturated carbon-carbon double bonds with an electron-withdrawing group; and
(3) a catalyst or latent catalyst C for initiating the Michael addition reaction.

2. The multilayer coating system according to claim 1, wherein the resin X in the isocyanate curing coating layer has a proportion of 0.5 wt % to 50 wt %.

3. The multilayer coating system according to claim 1, wherein the resin X contains a group that can react with the resin PA or the isocyanate curing agent PB, and the group is preferably a hydroxyl group or an isocyanate group; the hydroxyl group or the isocyanate group in the resin X has an equivalent of 100 g/mol to 10000 g/mol.

4. The multilayer coating system according to claim 3, wherein the activated methylene or methine group (CH) or the unsaturated carbon-carbon double bond with an electron-withdrawing group in the resin X has an equivalent of less than 5000 g/mol.

5. The multilayer coating system according to claim 1, wherein the resin X has a number-average molecular weight of less than 50000.

6. A coating method, comprising the following steps of:
S1, applying an isocyanate curing coating on a substrate surface, the isocyanate curing coating comprising:
(1) at least one hydroxyl-containing or amino-containing resin PA;
(2) at least one isocyanate curing agent PB;
(3) at least one resin X containing at least one activated methylene or methine group (CH) or one unsaturated carbon-carbon double bond with an electron-withdrawing group;
S2, curing or partially curing the isocyanate curing coating;
S3, applying a Real Michael addition crosslinkable coating on the cured isocyanate curing coating, the Real Michael addition crosslinkable coating comprising:
(1) at least one resin A containing two or more activated methylene or methine groups (CH);
(2) at least one resin B containing two or more unsaturated carbon-carbon double bonds with an electron-withdrawing group; and
(3) a catalyst or latent catalyst C for initiating the Michael addition reaction; and
S4, curing the Real Michael addition crosslinkable coating.

7. The coating method according to claim 6, further comprising applying a primer to the substrate surface in the step S1.

8. The coated substrate according to claim 10, wherein
the isocyanate curing coating layer and the Real Michael addition crosslinkable coating layer are respectively a primer and a topcoat of the coated substrate; or
the isocyanate curing coating layer and the Real Michael addition crosslinkable coating layer are respectively a middle coat and a topcoat of coated substrate; or
the isocyanate curing coating layer and the Real Michael addition crosslinkable coating layer are respectively a basecoat and a clearcoat of the coated substrate.

9. The coated substrate according to claim 8, wherein the Real Michael addition crosslinkable coating layer comprises at least two sublayers of the Real Michael addition crosslinkable coating layer.

10. A coated substrate, comprising:
a substrate; and
a coating comprising:
I. an isocyanate curing coating layer, comprising:
(1) at least one hydroxyl-containing or amino-containing resin PA;
(2) at least one isocyanate curing agent PB;
(3) at least one resin X containing at least one activated methylene or methine group (CH) or one unsaturated carbon-carbon double bond with an electron-withdrawing group;
II. a Real Michael addition crosslinkable coating layer coated on the isocyanate curing coating layer, comprising:
(1) at least one resin A containing two or more activated methylene or methine groups (CH);
(2) at least one resin B containing two or more unsaturated carbon-carbon double bonds with an electron-withdrawing group; and
(3) a catalyst or latent catalyst C for initiating the Michael addition reaction.

11. An isocyanate curing coating used as a primer for a Real Michael addition crosslinkable coating, comprising:
(1) at least one hydroxyl-containing or amino-containing resin PA;
(2) at least one isocyanate curing agent PB;
(3) at least one resin X containing an activated methylene or methine group (CH) or an unsaturated carbon-carbon double bond with an electron-withdrawing group.

12. The coating according to claim 11, wherein the resin X in the isocyanate curing coating has a proportion of 0.5 wt % to 50 wt %.

13. The coating according to claim 11, wherein the resin X contains a group which can react with the resin PA or the isocyanate curing agent PB, and the group is a hydroxyl group or an isocyanate group; the hydroxyl group or the isocyanate group in the resin X has an equivalent of 100 g/mol to 10000 g/mol.

14. The coating according to claim 11, wherein the activated methylene or methine group (CH) or the unsaturated carbon-carbon double bond with an electron-withdrawing group in the resin X has an equivalent of less than 5000 g/mol.

15. The coating according to claim 11, wherein the resin X has a number-average molecular weight of less than 50000.

16. (canceled)

17. (canceled)

18. The multilayer coating system of claim 1, further comprising a reaction regulator.
